(19) United States
(12) Patent Application Publication
(10) Pub. No.: US 2010/0288450 A1
(43) Pub. Date: Nov. 18, 2010

(54) PORTABLE SCENE ISOLATOR

(76) Inventors: Naftali Bruck, Brooklyn, NY (US); Yair Bruck, Brooklyn, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/465,298

(22) Filed: May 13, 2009

(51) Int. Cl. A47G 5/02; A47G 5/00; A47B 97/00; F16M 11/22

(52) U.S. Cl. 160/238; 160/351; 312/352; 248/176.1; 248/163.1; 160/405

(57) ABSTRACT

In one aspect, the present invention is directed to a septum apparatus (10), for concealing a site from passersby, the apparatus comprising: a first pole (40), comprising a plurality of segments (50), each storing a folded sheet (52); a second pole (20), comprising means for connecting thereto the end of each sheet (28), the second pole being foldable or telescopic, thereby providing a compact structure; each of the poles comprises a stand (42, 22), for retaining the pole thereof (40, 20 correspondingly) upright; and each pole (40, 20) comprises fixing means (12 or 46, 26), for fixing the pole thereof to the ground; thereby providing a septum compact in storage, simple in mounting and dismounting. The apparatus may further comprise a case (80), for storing therein the parts thereof.

### FIELD OF THE INVENTION

The present invention relates to the field of security devices. More particularly, the invention relates to a portable scene isolator, such as an apparatus for concealing the site of an accident from passersby, concealing a site in secured public places, and so forth.

### BACKGROUND OF THE INVENTION

The phenomenon of curious people gathering at the site of a recent automobile accident is well known. This phenomenon is more acute on highways, where passing drivers stop or slow down their cars in order to watch the event, resulting in severe traffic jams.

The attempts of the police to stop this situation usually fail, as human curiosity overcomes common sense.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a septum apparatus (10), for concealing a site from passersby, the apparatus comprising:
a first pole (40), comprising a plurality of segments (50), each storing a folded sheet (52);
a second pole (20), comprising means for connecting thereto the end of each of the sheets (28), the second pole being foldable or telescopic, thereby providing a compact structure;
each of the poles comprises a stand (42, 22), for retaining the pole thereof (40, 20 correspondingly) upright; and
each of the poles (40, 20) comprises fixing means (12 or 46, 26), for fixing the pole thereof to the ground;
   thereby providing a septum compact in storage and simple in mounting and dismounting.

The apparatus may further comprise a case (80), for storing therein the parts thereof.

The apparatus may further comprise rotating means, for rotating all the segments of the first pole together. According to one embodiment of the invention, the rotating means comprise a motor (60). According to another embodiment of the invention, the rotating means comprise a handle (70), for manually carrying out the rotation.

According to one embodiment of the invention, each of the segments (50) comprises a hinge (62) around which the sheet (52) of the segment is rolled, and connection means (64) to the hinge of the adjacent segment thereof.

According to another embodiment of the invention, each of the segments is in the form of a rigid cylinder, thereby providing a casing for storing the sheet thereof, wherein each of the cylinders comprises means for connecting to the adjacent cylinder thereof (e.g., the dimensions of one end of a cylinder allows mating with the end of an adjacent cylinder thereof).

According to one embodiment of the invention, each of the stands is foldable, thereby providing compact storage.

Preferably, each of the stands is in the form of a tripod. From this point of view, a four-legged tripod provides even greater stability in comparison to tripods of three legs.

According to one embodiment of the invention, the fixing means comprise weights, to enhance stability.

Additionally or alternatively, the fixing means comprise a rope and a peg for each of the poles.

Preferably, the first pole further comprises means (49) for connecting thereto the sheets of another pole, thereby enabling means for covering a longer area.

Preferably, the material that each the sheets is made of blocks visibility therethrough while allowing air passage therethrough.

In another aspect, the present invention is directed to a method for concealing a site from passersby, the method comprising the steps of:
providing a foldable septum apparatus (10) comprising two poles (40, 20) and a plurality of folded sheets (52), wherein the material of each sheet blocks visibility therethrough while allowing air passage therethrough;
fixing the poles to the ground;
unfolding the sheets together; and
connecting the sheets to the poles therebetween.

The method may further comprise the step of connecting to the septum apparatus an additional foldable septum apparatus in line.

The foregoing embodiments of the invention are described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a septum apparatus for concealing a site from passersby, according to one embodiment of the invention.

FIG. 2a further details the structure of pole 20.

FIG. 2b further details the structure of pole 40.

FIG. 3 details the interior components of a cylinder 50.

FIG. 4 is a perspective view of a cylinder 50 from the bottom side thereof.

FIG. 5 illustrates a casing 80, which stores the parts of the septum.

FIG. 6 schematically illustrates a sequence of septum apparatuses connected in line, according to one embodiment of the invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

The present invention deals with the above-mentioned objects by visual isolation of a site by a septum. The septum hides the scene from passersby, thereby eliminating stopping and staring on the continuing event. The septum is designed to be compact, thereby to be carried in a police car, and easy to be mounted, in order to shorten the mounting time as possible.

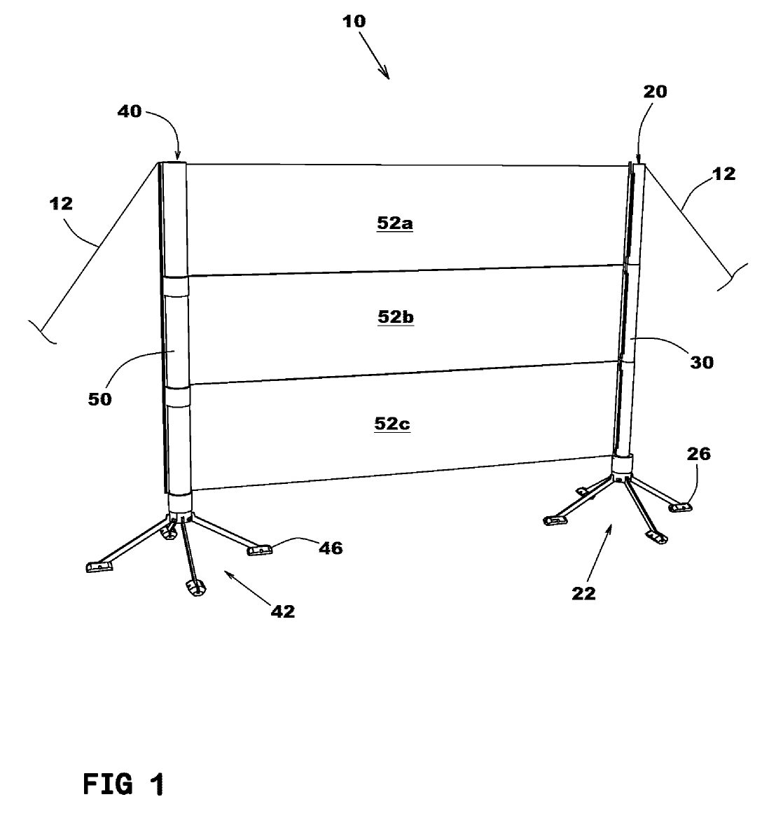

FIG. 1 schematically illustrates a septum apparatus for concealing a site from people passing by, according to one embodiment of the invention.

The septum apparatus, which is marked herein by reference numeral 10, comprises a plurality of fabric sheets 52i connected to poles 20 and 40 on each side thereof.

Pole 20 stands on a tripod 22, and pole 40 stands on a tripod 42. The role of the tripods is to keep the poles upright.

Since the fabric sheets are exposed to wind, they act as sails, resulting in pushing the septum until it collapses.

According to one embodiment of the invention, this problem is solved by adding to each side of the apparatus a supporting rope 12, connected to a peg (not illustrated). Additionally or alternatively, each of the tripods 22 and 42 comprises weights, such as weights 26 and 46, connected to the legs of the tripod thereof.

Additionally or alternatively, the fabric may comprise cavities (not illustrated), to allow the wind to pass through, thereby eliminating the fabric to act as a sail.

But, even if the fabric does not comprise cavities, the wind may pass through opening between each of two adjacent sheets.

Cylinders 50i may be connected to each other by, for example, different diameter at each end thereof, which allows interlocking two adjacent cylinders each other. Of course, this is merely an example, and other connection means can be used.

As will be detailed hereinafter, the structure of septum apparatus 10 is designed to allow easy mounting and dismounting, and compact storage. As a result, the apparatus can be stored in a trunk of a police car, and instantly mounted when a need rises.

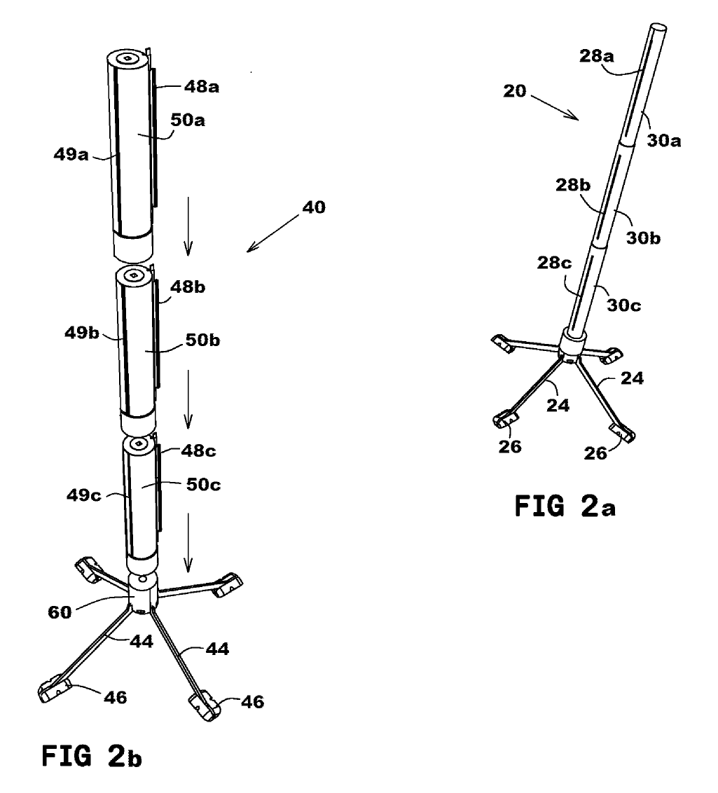

FIG. 2a further details the structure of pole 20. As mentioned, pole 20 is telescopic, i.e., comprises a plurality of interlaced segments 30i. Each of segments 30i comprises a connector 28i, to which a sheet 52i is connected via a corresponding male connector 48i. In the example herein, a connector 28i is in the form of a slot.

FIG. 2b further details the structure of pole 40. Pole 40 comprises a plurality of cylinders 50i, connected to each other. In this figure, the cylinders are separated in order to present the structure thereof. Each of the cylinders is also used as housing for a folded fabric sheet (not seen in this figure). At the end of each fabric sheet is installed a male connector 48i, corresponding to female connector 28i of pole 20.

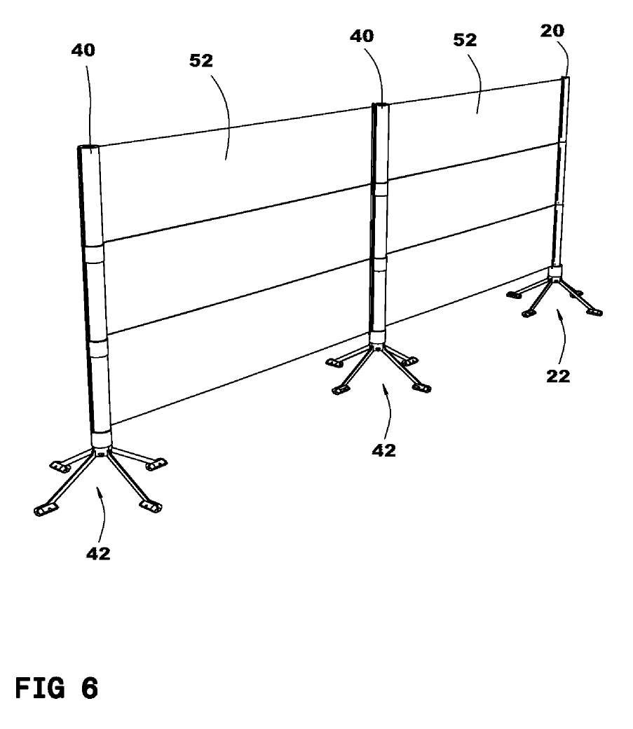

Each cylinder also comprises a connector 49i, in the form of connectors 28i, thereby allowing sequential connecting of a plurality of fabric sheets, thereby allowing increasing the covered length, as illustrated in FIG. 6.

Reference numeral 60 denotes an electric motor, which rotates the rolled curtain attached to the motor. In this way, folding and/or unfolding the curtain is carried out in an easy and simple manner.

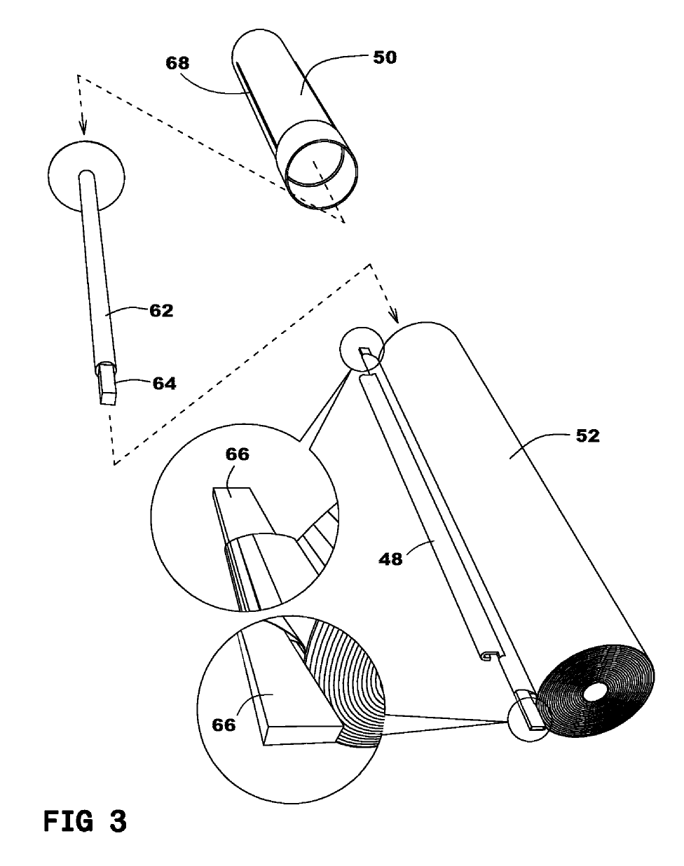

FIG. 3 details the interior components of a cylinder 50.

Reference numeral 68 denotes a slot through which curtain 52 springs from the cylinder. A profile 66 connected to the end of the curtain is used to prevent the end of curtain 52 from entering the cylinder. According to this example, male connector 48 is a part of profile 66. Male connector 48 is in the form of a hook, but this is merely an example, and other types of connectors may be used.

Numeral 62 denotes a hinge around which curtain 52 is rolled. One end of hinge 62, which is marked by reference numeral 64, has a square contour. It connects as a male connector to the end of the hinge of the adjacent cylinder. As illustrated in FIG. 1, cylinders 50 connect with each other to compose a pole. Thus, each end of a hinge has a square profile, but while one end is used as a male connector, the other serves as a corresponding female connector. The result is that all hinges are rotated together, i.e., when rotating the hinge of the lower cylinder, the entire septum is opened or closed according to the rotation direction.

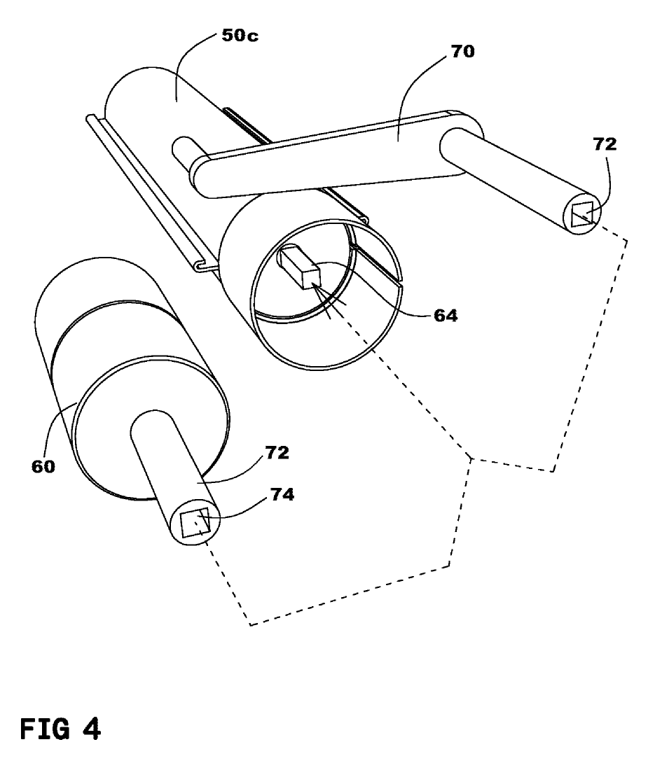

FIG. 4 is a perspective view of a cylinder 50 from the bottom side thereof. It further details the structure of the septum apparatus 10.

Reference numeral 64 denotes the end of hinge 62 of cylinder 50. End 64 has a square profile, and is used as a male connector. The square profile of end 64 corresponds to that of driveshaft 72 of motor 60, i.e., end 74 is used as a female connector corresponding to male connector 64. Thus, by connecting end 74 of driveshaft 72 to end 64 of the hinge of cylinder 50, the curtain of cylinder 50 is rotated.

Numeral 70 is a handle, which can be connected by connector 72 to end 64 of a cylinder's hinge.

Thus, according to one embodiment of the invention, hinge 62 is rotated by motor 60, and according to another embodiment of the invention, it is rotated manually by handle 70.

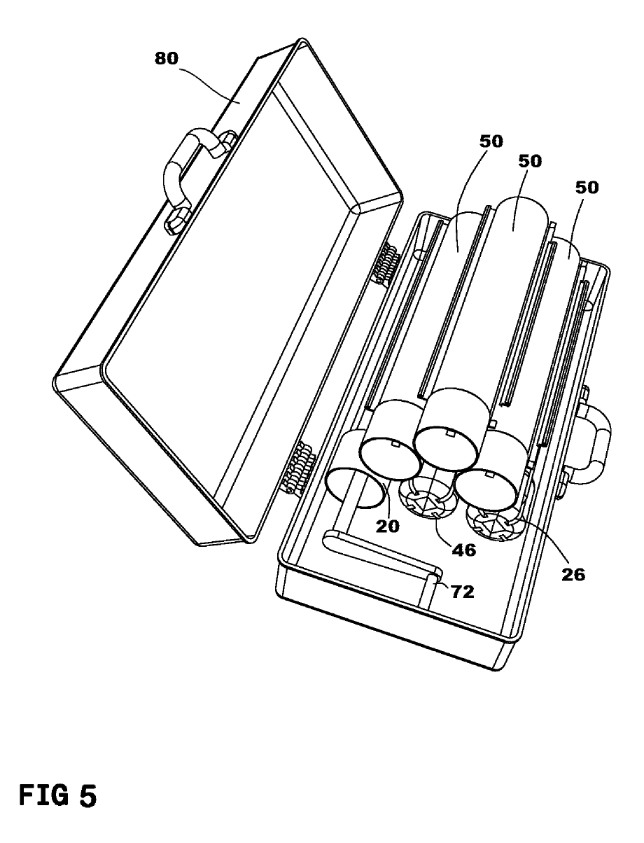

FIG. 5 illustrates a casing 80, which stores the parts of the septum. As a pole 40 comprises a plurality of segments, the segments (cylinders) can be stored in a casing that can be easily placed in a car trunk.

FIG. 6 schematically illustrates a sequence of septum apparatuses connected in line, according to one embodiment of the invention.

As mentioned above, each of the cylinders also comprises a connector 49i, in the form of connectors 28i, thereby allowing connecting a plurality of fabric sheets in line, thereby allowing increasing the covered length. For example, it is common that a plurality of police cars arrive at the site of an accident. By using the septum apparatus of each car, the covered length can be increased.

In the figures and/or description herein, the following reference numerals have been mentioned:
numeral 10 denotes a septum apparatus, according to one embodiment of the invention;
numeral 12 denotes a rope to be connected to a peg, in order to fix the septum apparatus to the ground;
numeral 20 denotes a telescopic pole;
numeral 22 denotes a tripod of pole 20;
numeral 24 denotes a leg of tripod 22;
numeral 26 denotes a weight attached to leg 24;
numeral 28 denotes a female connector;
numeral 30 denotes a segment of pole 20;
numeral 40 denotes a pole composed of cylinders, each cylinder storing a folded fabric sheet 52;
numeral 42 denotes a tripod of pole 40;
numeral 44 denotes a leg of tripod 42;
numeral 46 denotes a weight attached to leg 44, for fixing the pole thereof to the ground;
numeral 48 denotes a male connector corresponding to female connector 28 and also to female connector 49;
numeral 49 denotes a female connector corresponding to male connector 48;
numeral 50 denotes a cylinder storing a folded curtain 52;
numeral 52 denotes a curtain;
numeral 54 denotes a handle for rotating curtain 52 of cylinder 50;
numeral 60 denotes an electric motor;
numeral 62 denotes a hinge on which curtain 52 is rolled;
numeral 64 denotes an end of hinge 62 (the end is also used as a male connector);
numeral 66 denotes a profile connected to the end of curtain 52, and is used as a barrier preventing the end from entry to the cylinder thereof;
numeral 68 denotes a slot through which curtain 52 emerges from cylinder 50;
numeral 70 denotes a handle, for rotating hinge 62; and
numeral 80 denotes a case, for storing parts of apparatus 10.

The foregoing description and illustrations of the embodiments of the invention has been presented for the purposes of illustration. It is not intended to be exhaustive or to limit the invention to the above description in any form.

What is claimed is:

1. A septum apparatus, for concealing a site from passersby, the apparatus comprising:
a first pole, comprising a plurality of segments, each storing a folded sheet;
a second pole, comprising means for connecting thereto the end of each of said sheets, said second pole being foldable or telescopic, thereby providing a compact structure;
each of the poles comprises a stand, for retaining the pole thereof upright; and
each of the poles comprises fixing means, for fixing the pole thereof to the ground;
thereby providing a septum compact in storage, portable, simple to mount and dismount.

2. An apparatus according to claim 1, further comprising a case, for storing therein the parts thereof.

3. An apparatus according to claim 1, further comprising rotating means, for rotating all the segments of said first pole together.

4. An apparatus according to claim 3, wherein said rotating means comprise a motor.

5. An apparatus according to claim 3, wherein said rotating means comprise a handle.

6. An apparatus according to claim 1, wherein each of said segments comprises a hinge around which the sheet of said segment is rolled, and connection means to the hinge of the adjacent segment thereof.

7. An apparatus according to claim 1, wherein each of said segments comprises a rigid cylinder, providing a casing for storing the sheet thereof.

8. An apparatus according to claim 7, wherein each of said cylinders comprises means for connecting to the adjacent cylinder thereof.

9. An apparatus according to claim 1, wherein each of said stands is foldable.

10. An apparatus according to claim 1, wherein said stand is in the form of a tripod.

11. An apparatus according to claim 10, wherein said tripod comprises four legs.

12. An apparatus according to claim 1, wherein said fixing means comprises a weight.

13. An apparatus according to claim 1, wherein said fixing means comprise a rope and a peg for each of the poles.

14. An apparatus according to claim 1, wherein said first pole further comprises means for connecting thereto the sheets of another pole, thereby enabling means for covering a greater area.

15. An apparatus according to claim 1, wherein the material of which each of the sheets is made of blocks visibility therethrough while allowing air passage therethrough.

16. A method for concealing a site from passersby, the method comprising the steps of:
providing a foldable septum apparatus comprising two poles and a plurality of folded sheets;
fixing said poles to the ground;
unfolding said sheets together; and
connecting said sheets to said poles therebetween.

17. A method according to claim 16, further comprising the step of connecting to said septum apparatus an additional foldable septum apparatus in line.
